(19) United States
(12) Patent Application Publication
(10) Pub. No.: US 2022/0036719 A1
(43) Pub. Date: Feb. 3, 2022

(54) DEVICE AND METHOD FOR MONITORING A SITUATION WITHIN A VOLUME

(71) Applicant: KAPELSE, Villers les Nancy (FR)

(72) Inventors: Luc DEBORGIES, Versailles (FR); Flore ROCCA, Vaucresson (FR)

(21) Appl. No.: 17/414,088

(22) PCT Filed: Dec. 16, 2019
(86) PCT No.: PCT/EP19/85423

§ 371 Date: Jun. 15, 2021

(30) Foreign Application Priority Data
Dec. 21, 2018 (FR) 1873733

(51) Int. Cl. G08B 21/22; G08B 23/00; G08B 7/06; G08B 25/10

(52) U.S. Cl. CPC G08B 21/22; G08B 25/10; G08B 7/06; G08B 23/00

(57) ABSTRACT

The device for monitoring a situation within a volume includes at least one electronic unit containing a plurality of different types of sensors, at least one program for controlling the sensors according to a predefined profile and a program for processing data recorded by the sensors, a device for signaling the detection of data representative of an event within the volume, a remote management unit and device for exchanging data between the electronic unit and the remote management unit defined by a radio transmitter/receiver that includes the electronic unit and the remote management unit. The electronic unit includes a device for manual activation of the radio emitter, defined by a button arranged on a housing for an infrared presence sensor equipped with its lens forming a protuberance on the outer face of the unit. The invention also concerns a method for monitoring a situation within the volume by the device.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The object of the present invention is, on the one hand, a device for remote monitoring or not of a state or situation within a given environment, such as for example the state of a frail person maintained at home, or the control of the environment, etc., and on the other hand a method for remote monitoring or not of a situation within a volume.

### 2. Description of Related Art Including Information Disclosed Under 37 CFR 1.97 and 37 CFR 1.98.

At present, various more or less elaborate electronic devices, based on the implementation of data sensors and, if necessary, means of analysis of the data recorded, have been developed for this purpose, are already available on the market, and have been the subject of publications. In this regard, documents US 2016/0203692, FR 2 863 396 and US 2012/0286949 describe different solutions of this type, each dedicated to a particular application.

However, it has been observed that the various proposed devices suffer from a number of drawbacks, and do not always satisfactorily meet the expectations or needs of users.

Thus, the devices integrating only one type of sensor are by definition limited to the control of a single data and consequently unsuitable for complex applications requiring the follow-up of a plurality of different parameters.

On the other hand, devices that integrate a plurality of sensors are particularly energy consuming and generally take up a lot of space. In short, their installation is tedious, especially in environments requiring their discretion, and their implementation implies a permanent verification of the batteries' charge level, as well as a frequent replacement of the latter, in order to avoid any failure.

Furthermore, conventional systems rely on the transmission of raw data generated directly by the sensors to a possible analysis tool, without any special processing. In order for this raw data to be usable, relevant, and meaningful, it is necessary to have, in addition to the measuring device, an expert system deported to one or more servers. Such an architecture implies not only a very high initial cost, because of its heaviness, but also a complexity of implementation, due to the need to provide a computer server and the diversity of the dedicated sensors used, implying the same diversity in terms of communication protocols.

Also, it has been found that the implementation principle of some existing installations can be complex under certain circumstances, and lead to late reactions with detrimental consequences.

The purpose of the present invention is to overcome these various disadvantages, by proposing a solution that is both multi-purpose and energy-efficient, based on a compact data capture device, and a reliable, efficient and architecturally simplified data analysis system, which also differs from existing solutions in that it is more intuitive to use.

### BRIEF SUMMARY OF THE INVENTION

In other words, the object of the invention is to provide a solution with a universal character, which is suitable for many different applications through a simple prior parameterization of the multiple sensors that it integrates, whose constituent elements allow a discreet installation, respectful of the environment of use, thanks to a minimalist size, whose autonomy is considerably improved compared to conventional solutions to extend up to three years with an ordinary type battery, and which comprises means of triggering alarms whose mode of implementation is obvious.

To this end, the object of the invention is a device for monitoring a situation within a volume, comprising at least one electronic unit containing:
a plurality of sensors of different type,
a microcontroller for managing the sensors comprising memory means,
at least one program for controlling the sensors according to a predefined profile and a program for processing the data recorded by the sensors, stored in the said memory means,
means for signaling the detection of data representative of the occurrence of a particular event within the volume,
means for supplying electrical energy, and
means for manual activation of the radio transmitter of the electronic unit, characterized in that the manual activation means are defined by a button arranged on a housing dedicated to an infrared presence sensor provided with its lens forming a protuberance on the outer face of the housing.

In accordance with a preferred variant, the sensors are chosen from the group comprising a temperature sensor, a humidity sensor, an accelerometer, a magnetometer, a vibration sensor, a luminosity sensor and an infrared presence sensor.

Of course, sensors of a different nature can also be provided through other alternative embodiments specifically adapted to the applications considered.

In accordance with the invention, it is also provided that the sensors are preferably of the very low energy consumption type.

An additional characteristic of the device according to the invention is represented by the fact that the means of signaling the detection of data representative of a particular event are defined by at least one indicator lamp, and/or an audible warning means.

Furthermore, a remote management unit and means for exchanging data between the electronic unit and the remote management unit can also complete the device according to the invention.

In this case, the remote management unit preferably comprises :
a microcontroller for remote management of the electronic unit, comprising memory means,
a program for remote selection of a particular sensor control profile, stored in the memory means, as well as a program for processing data transmitted by the electronic unit, and
an interface for using the program for remote selection of a particular sensor control profile and/or the program for processing data transmitted by the electronic unit.

According to a conceivable option, the data exchange means are defined by a radio transmitter/receiver that the electronic unit and the remote management unit comprise.

Within the framework of the invention, it has also been imagined that the electronic unit comprises means for manual activation of the radio transmitter of the electronic unit.

These manual activation means can advantageously be defined by a button placed on a housing dedicated to an infrared presence sensor equipped with its lens forming a protuberance on the outer face of the unit.

Furthermore, the device according to the invention may also comprise a central unit and means for transmitting data between the said remote management unit and the said central unit.

The invention also relates to a method of monitoring a situation within a volume, by means of a device as previously described, characterized in that it comprises the following steps:
a plurality of profiles is defined, each grouping a set of parameters specific to a given application of the electronic unit,
the plurality of profiles is stored in the sensor control program within the electronic unit,
the electronic unit is installed in the volume to be monitored,
one of the profiles is selected to automatically activate at least one of the sensors of the electronic unit,
a signal is recovered which is representative of the occurrence of an event within the volume, and whose emission is caused by the detection of a data item, as the case may be, recorded by one of the sensors or resulting from the processing of the data recorded by at least one of the sensors, and corresponding to a data item known as “threshold data”.

In accordance with a characteristic of the method, in order to define the plurality of profiles, the following is established for each of them:
a list of automatically activated sensors,
a frequency of measurements for each of the automatically activated sensors,
a list of values from which a data item recorded by one of the automatically activated sensors or resulting from the processing of data recorded by the automatically activated sensors corresponds to a “threshold data item”.

A subsidiary characteristic is further defined by the fact that, in order to define the plurality of profiles, the following is also established for each of them :
a list of subsidiary sensors that can be automatically activated in the event of detection, by at least one automatically activated sensor, of data corresponding to a threshold data, and/or
a list of sensors whose frequency of measurements can be automatically modified in the event of detection, by at least one automatically activated sensor, of data corresponding to a threshold data.

It has also been imagined that the signal representative of the occurrence of an event within the volume can be recovered from the electronic unit and/or from the remote management unit.

As the case may be, the signal representative of the occurrence of an event may be retrieved in the form of a light signal and/or a sound signal and/or a time-stamped message contained in a primary computer frame.

In addition, the method according to the invention may comprise a step consisting of retrieving periodically, at the remote management unit, all the data read by the sensors and/or all the data processed by the data processing program in the form of a time-stamped message contained in a secondary computer frame.

The latter can be recovered manually by a step of activating the button on the electronic unit.

Alternatively, the secondary computer frame can be recovered automatically by integrating, during the step of defining the profiles, in each of these profiles, a transmission frequency of all the data recorded by the sensors and/or all the data processed by the data processing program, from the electronic unit to the remote management unit.

### BRIEF DESCRIPTION OF THE SEVERAL VIEWS OF THE DRAWINGS

The invention will be better understood, and other features and advantages of the invention will become apparent from the following description of two non-limiting examples of implementation of the method according to the invention.

The description should be read in conjunction with the attached drawings.

FIG. 1 is a schematic view of a diagram of an alternative embodiment of the device according to the invention, suitable, for example, for monitoring the entry/exit of a person from a living volume.

FIG. 2 is a flow chart of the implementation method of the device of FIG. 1, applied to the monitoring of the entries/exits of a person from a living volume.

### DETAILED DESCRIPTION OF THE INVENTION

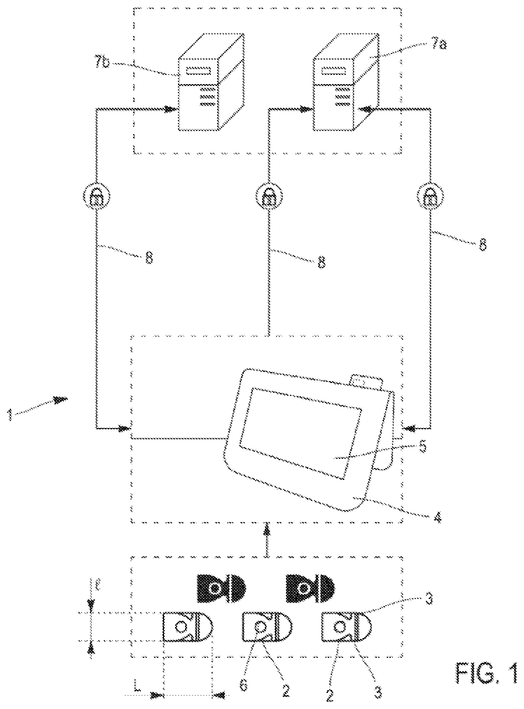

In the alternative embodiment shown in FIG. 1, the device 1 according to the invention comprises a plurality of multi-purpose electronic units 2, intended to be installed within a volume to be monitored, such as for example a living space, and capable of detecting a certain number of physical quantities there, through the implementation of different sensors.

In order to contribute to this versatility and to allow a reliable monitoring, each of the electronic units 2 embeds, in a standard way, on the same electronic card a temperature sensor, a humidity sensor, an accelerometer, a magnetometer, a vibration sensor, a luminosity sensor and an infrared presence sensor.

Of course, this list of sensors must be interpreted as being specific to the alternative embodiment described and is likely to evolve according to the targeted applications.

In this case, any data recorded by an additional sensor integrated into the electronic unit 2 will be processed by the same on-board intelligence as those recorded by the other sensors. However, as will be described in more detail below, all the sensors embedded in the same unit 2 are not necessarily activated permanently, but only when the application in question requires it, or when a data item detected by an already active sensor causes them to be activated, which represents an undeniable advantage in terms of energy savings.

Furthermore, with the same objective of limiting the energy consumption of the device according to the invention as much as possible, the sensors installed on the electronic unit 2 are of the very low energy consumption type.

It should also be noted that the electronic units 2 advantageously present a very compact structure, and very small dimensions (of the order of 3 cm width I and 5 cm length L, in the shown example), conferring great discretion and facilitating both their installation and their integration in a volume, such as a living space in which a given situation is to be monitored.

On the other hand, each electronic unit 2 is equipped with a microcontroller for managing the sensors, comprising memory means in which are stored at least one program for controlling the sensors according to a predefined profile and a program for processing the data recorded by the sensors, as well as indicator lamps 3, and an audible warning means (not illustrated). The electrical power supply of the electronic units 2 is ensured by a conventional battery, of the 3V-600 mAh type.

In the alternative embodiment shown, the device according to the invention also comprises a remote management unit 4, equipped with a microcontroller for remote management of the electronic units 2, comprising memory means in which a program for remote selection of a particular sensor control profile is stored, as well as an interface 5 for using this program.

Moreover, in order to authorize an exchange of data between the remote management unit 4 and the electronic units 2, each of them integrates a radio transmitter/receiver. It is also specified that all of these exchanges are preferably encrypted to ensure their security and confidentiality.

In addition, the electronic unit 2 comprises a button 6, advantageously arranged on a housing dedicated to an infrared presence sensor provided with its lens forming a protuberance on its outer face and defining a means of manual activation of the radio transmitter that it integrates.

Two central units 7a, 7b, capable of communicating with the remote management unit 4, by means of secure data transmission 8 based, for example, on encryption of the transmitted radio data, also complete the device 1 according to the invention shown in FIG. 1. They perform various functions, comprising in particular the storage of data relating to the management of the electronic units 2 and of the remote management unit 4, and the updating of the programs that this equipment incorporates.

In order to achieve the above-mentioned objectives, aiming in particular at providing a solution with a universal vocation, and very economical in terms of energy, the implementation of the device 1 according to the invention is via an innovative process which allows both to optimize the operating times of the sensors and to limit the transmission of information or the exchange of data to only those which are useful.

Within the framework of this method, each electronic unit 2 is provided with a library of profiles, previously defined, each grouping a set of parameters specific to a given application and making it possible to dedicate the units 2 to multiple uses, by the prior selection of the corresponding profile.

More precisely, in order to define the plurality of profiles likely to be stored in each electronic unit 2, a list of automatically activated sensors, a frequency of measurement readings for each of the “automatically” activated sensors, and a list of values from which a data item read by one of the automatically activated sensors or resulting from the processing of data read by the automatically activated sensors corresponding to a “threshold data item” is established for each of them.

In practice, the profile selection step is preferably carried out after the installation of the electronic unit(s) 2 in the volume to be monitored, for example by means of a remote management unit 4 and leads to the activation of only those sensors required by the application in question.

In other words, for each application, the sensor control program of the electronic unit(s) 2 will exploit the relevant profile to automatically activate one or more sensors that will operate in accordance with the parameters of this same profile.

During the monitoring method, the data recorded by the sensors is analyzed within the electronic unit 2, by the data processing program that it integrates, and is compared with the data, called “threshold data”, recorded in the profile.

In order to limit the electrical energy consumption of the device according to the invention, a signal representative of the occurrence of an event within the monitored volume is then recovered only in the event of the detection of a data which turns out, according to the case before or after analysis, to correspond to a “threshold data”.

Thus, depending on the case, the occurrence of an event can be signaled through a signal whose emission is activated by the detection of a raw data, or a processed data, each corresponding to a threshold data.

Furthermore, the invention is also based on a dynamic and permanent optimization of the intelligence embedded in the electronic unit 2, which induces an interoperability of the sensors integrated in this same electronic unit 2 and a correlation of the data recorded by each of them.

Indeed, the invention provides that for certain profiles recorded in the memory means of the electronic unit 2, a list of subsidiary sensors likely to be activated automatically, in the event of detection, by at least one automatically activated sensor, of data corresponding to a threshold data, and/or a list of sensors whose frequency of measurement readings is likely to be modified automatically in the event of detection, by at least one automatically activated sensor, of data corresponding to a threshold data, is also established for each of them.

Such a characteristic also makes it possible to limit the electrical energy requirements of the device 1 according to the invention, the sensors only coming out of their standby mode at specific times, defined by the profile parameters, and remaining inactive, and therefore not supplied with energy, the rest of the time.

The method according to the invention also provides for the possibility of recovering the signal representing the occurrence of an event within the volume directly by an electronic unit 2, in the form of a light signal and/or a sound signal, and/or by a remote management unit 4, in the form of a time-stamped message contained in a primary computer frame.

Of course, it is also possible to periodically retrieve, at the remote management unit 4, in the form of a time-stamped message contained in a secondary computer frame, all of the raw data recorded by the sensors and/or all of the data processed by the data processing program of each electronic unit 2. This step can be carried out manually, by activating the button 6 on the electronic unit 2. According to another option, it can also be carried out automatically, by integrating in each of the profiles a transmission frequency, from the electronic unit 2 to the remote management unit 4, of all the raw data recorded by the sensors and/or all the data processed by the data processing program.

When the device 1, according to the invention, comprises a plurality of electronic units 2, it is advantageously provided that the occurrence of an event within the volume can be detected by the remote management unit 4, following a computer processing of the data contained in the primary and/or secondary computer frames from each of the units 2. In short, the aggregation and processing of data from different units 2 installed in a volume and, if necessary, parameterized for different applications, at the remote management unit 4, allows the detection by the latter, of the occurrence of an event which might have escaped a unit 2 considered in isolation.

It is clear from the foregoing that the device 1 according to the invention makes it possible to achieve the objectives stated in the preamble.

Thanks to the implementation of a library of profiles, each representative of a different application, the device according to the invention is universal. It can, for example, be placed in a living volume and, following the activation of the corresponding profile, retrieve environmental data such as temperature, humidity, and luminosity, as well as the state of occupation of this same volume. An installation on a drawer or a cupboard allows, according to another example of implementation, to detect the openings and closings of these, again after selection of the corresponding profile and thus activation of the required sensors. Placed in a refrigerator, the device according to the invention makes it possible to monitor the temperature inside the refrigerator at regular intervals and to alert the user in the event that the temperature exceeds a monitoring range, also by selecting the profile provided for this purpose.

The device according to the invention is also evolutive, since it can be used for a certain period of time for a first application, then for a second application during a second period, etc., by simply reprogramming and selecting a different profile.

Furthermore, thanks to the compact structure and reduced dimensions of the electronic unit 2, the device 1 according to the invention is discrete and does not alter the general ambiance of the environment in which it is installed.

Because all the sensors are of the low energy consumption type and are only activated when needed and the signals are only emitted when an alarm is detected, it is energy efficient and can last up to three years.

In this respect, it should also be noted that within the framework of the invention, it may be provided to determine permanently the energy expended by the electronic unit 2 and consequently to deduce from it the remaining charge as well as the duration of operation, in order to be able to anticipate the recharging or the replacement of the battery and to avoid any untimely failure.

Also, the electronic unit 2 is preferably equipped with a USB connector (universal serial bus) allowing it to be coupled with a remote management unit 4 that can be defined by any current computer equipment equipped with a USB socket, such as a personal computer, an internet unit, etc.

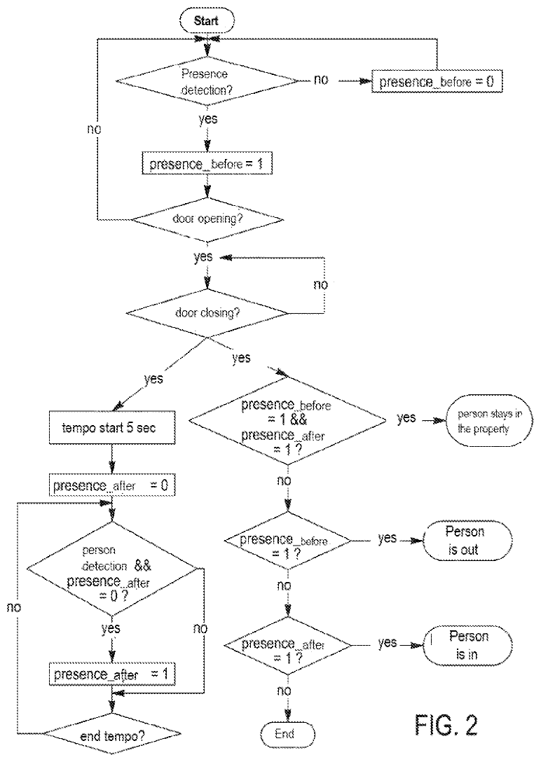

FIG. 2 attached illustrates the logic implemented by the process according to the invention, in the context of the use of the device 1 to monitor the entries and exits of a person from a living volume, and the duration of inoccupation of this same living volume, after the person has left. This figure also illustrates the nature of the information deduced from the data recorded by the sensors and constituting messages representative of a situation.

In such an application, the selected profile must allow a necessary and sufficient feedback of door movements and presence data to be informed of the entries and exits of a person from his home or from a specific volume of the latter. It must also allow to estimate the time of occupation or non-occupation of a volume, in order to deduce the location and the movements of a person within his home.

For this purpose, the activation of the infrared presence sensor, the accelerometer (translation detection) and the magnetometer (rotation detection) is necessary. Furthermore, the corresponding profile integrates a certain number of parameters, relating in particular to the nature of the door, to the duration of opening of the door corresponding to a threshold data, to the readings which trigger, after correlation with other data read by other sensors, the emission of a signal or even to the quantity of movements which must be detected to validate a presence in the volume and thus the emission of a signal.

In accordance with the invention, in this application, the autonomy of the device 1 is prolonged thanks to a correlation between the door movement information (translation/rotation) and the presence information. Thus, for example, when no presence in a volume is detected, the measurement frequency of the accelerometer and magnetometer is automatically reduced. In the same way, the frequency of the measurements taken by the presence detector can be modified according to the occupancy rate of the volume detected.

1. A device for monitoring a situation within a volume, comprising:
at least one electronic unit being comprised of:
a plurality of sensors of different type,
a microcontroller for managing the sensors comprising memory means,
at least one program for controlling the sensors according to a predefined profile and a program for processing data recorded by the sensors, stored in the said memory means,
means for signaling the detection of data representative of the occurrence of a particular event within the volume
means for supplying electrical energy; and
a remote management unit and means for exchanging data between the electronic unit and the remote management unit defined by a radio transmitter/receiver being comprised of the electronic unit and the remote management unit, said electronic unit comprising means for manual activation of the radio transmitter,
wherein the manual activation means are defined by a button arranged on a housing dedicated to an infrared presence sensor provided with its lens forming a protuberance on the outer face of the case.

2. The device according to claim 1, wherein the sensors are chosen from the group comprising a temperature sensor, a humidity sensor, an accelerometer, a magnetometer, a vibration sensor, a luminosity sensor, an infrared presence sensor.

3. The device according to claim 1, wherein the sensors are of the very low power consumption type.

4. The device according to claim 1, wherein the means of signaling the detection of data representative of a particular event are defined by at least one indicator lamp, and/or a sound warning means.

5. The device according to claim 1, wherein the remote management unit comprises-:
a microcontroller for remote management of the electronic unit, comprising memory means,
a program for remote selection of a particular sensor control profile, as well as a program for processing data transmitted by the electronic unit stored in the memory means, and
an interface for using the program for remote selection of a particular sensor control profile and/or the program for processing data transmitted by the electronic unit.

6. The device according to claim 1, further comprising: at least one central unit and means for transmitting data between the said remote management unit and the said central unit.

7. A method for monitoring a situation within a volume, comprising the following steps:
a plurality of profiles are defined, each grouping a set of parameters specific to a given application of the electronic unit (2) of claim 1, by establishing for each of them:
a list of automatically activated sensors,
a frequency of measurements for each of the automatically activated sensors,
a list of values from which data read by one of the automatically activated sensors or resulting from the processing of data read by the automatically activated sensors corresponds to a “threshold data item”,
the plurality of profiles is stored in the sensor control program of the electronic unit,
the electronic unit is installed in the volume to be monitored,
one of the profiles is selected to automatically activate at least one of the sensors comprised within the electronic unit,
a signal is recovered which is representative of the occurrence of an event within the volume, and the emission of which is caused by the detection of a data item, as the case may be, recorded by one of the sensors or resulting from the processing of the data recorded by at least one of the sensors, and corresponding to a data item known as “threshold data item”,
wherein, in order to define the plurality of profiles, there is in addition, and for each one, a list established including:
a list of subsidiary sensors capable of being activated automatically, in the event of detection, by at least one automatically activated sensor, of data corresponding to a threshold data item, and/or
a list of sensors whose measurement reading frequency can be automatically modified in the event of detection, by at least one automatically activated sensor, of data corresponding to a threshold data item.

8. The method according to claim 7, wherein the signal representative of the occurrence of an event within the volume is recovered from the electronic unit and/or from the remote management unit.

9. The method according to claim 8, wherein the signal representative of the occurrence of an event is recovered in the form of a light signal and/or a sound signal and/or a time-stamped message contained in a primary computer frame.

10. The method according to claim 7, wherein all the data read by the sensors and/or all the data processed by the data processing program is periodically recovered from the remote management unit in the form of a time-stamped message contained in a secondary computer frame.

11. The method according to claim 10, wherein the secondary computer frame is recovered manually by activating the button comprised within the electronic unit.

12. The method according to claim 10, wherein the secondary computer frame is recovered automatically by integrating into each of the profiles a frequency of transmission of all the data read by the sensors and/or all the data processed by the data processing program, from the electronic unit to the remote management unit.
